(19) United States
(12) Patent Application Publication
(10) Pub. No.: US 2023/0110940 A1
(43) Pub. Date: Apr. 13, 2023

(54) WELDING METHOD, LASER WELDING SYSTEM, METALLIC MEMBER, ELECTRIC COMPONENT, AND ELECTRONIC APPLIANCE

(71) Applicant: FURUKAWA ELECTRIC CO., LTD., Tokyo (JP)

(72) Inventors: Nobuyasu MATSUMOTO, Tokyo (JP); Fumika NISHINO, Tokyo (JP); Tomomichi YASUOKA, Tokyo (JP); Jun TERADA, Tokyo (JP); Daeyoul YOON, Tokyo (JP); Kazuyuki UMENO, Tokyo (JP); Masamitsu KANEKO, Tokyo (JP)

(73) Assignee: FURUKAWA ELECTRIC CO., LTD., Tokyo (JP)

(21) Appl. No.: 17/930,869

(22) Filed: Sep. 9, 2022

Related U.S. Application Data
(63) Continuation of application No. PCT/JP2021/010247, filed on Mar. 12, 2021.

(30) Foreign Application Priority Data
Mar. 13, 2020 (JP) 2020-044765
Jun. 4, 2020 (JP) 2020-097702

(51) Int. Cl. B23K 26/067; B23K 26/70

(52) U.S. Cl. CPC B23K 26/067; B23K 26/703

(57) ABSTRACT

A welding method includes performing welding by emitting laser light moving in a sweeping direction relatively to a processing object onto a surface of the processing object to melt a portion of the processing object onto which the laser light is emitted, wherein the laser light includes: first laser light having a wavelength equal to or larger than 800 nm and equal to or smaller than 1200 nm; and second laser light having a wavelength equal to or smaller than 550 nm.

This application is a continuation of International Application No. PCT/JP2021/010247, filed on Mar. 12, 2021 which claims the benefit of priority of the prior Japanese Patent Application No. 2020-044765, filed on Mar. 13, 2020 and Japanese Patent Application No. 2020-097702, filed on Jun. 4, 2020, the entire contents of which are incorporated herein by reference.

### BACKGROUND

The present disclosure relates to a welding method, a laser welding system, a metallic member, an electric component, and an electronic appliance.

As one of methods for welding a processing object made of a metallic material, there is known laser welding. The laser welding is a welding method for irradiating a portion to be welded of a processing object with laser light, and melting the portion by energy of the laser light. The welding involves forming a liquid pool of molten metallic material that is called a molten pool at the portion irradiated with laser light, and solidifying the molten pool thereafter.

At the time of emitting laser light onto the processing object, a profile of the laser light may be formed depending on a purpose. For example, there is known a technique of forming a profile of laser light in a case of using the laser light for cutting a processing object (for example, refer to Japanese Translation of PCT International Application Publication No. 2010-508149).

### SUMMARY

At the time of welding, there is a demand for suppressing a welding defect such as spatters or blow holes. Spatters are molten metal that has scattered, so that a metallic material at a welding point is assumed to be reduced when the spatters are generated. That is, when a generation amount of spatters is increased, the metallic material at the welding point runs short to cause strength failure and the like. The generated spatters adhere to a periphery of the welding point. Thereafter, if the spatters come off therefrom and adhere to an electric circuit and the like, an anomaly occurs in the electric circuit. Thus, welding is difficult to be performed on a component for electric circuits in some cases. The blow hole is a cavity having a substantially spherical shape generated at a weld part, and may cause lowering of welding strength.

There is a need for a welding method, a laser welding system, a metallic member, an electric component, and an electronic appliance that may further suppress a welding defect.

According to one aspect of the present disclosure, there is provided a welding method including performing welding by emitting laser light moving in a sweeping direction relatively to a processing object onto a surface of the processing object to melt a portion of the processing object onto which the laser light is emitted, wherein the laser light includes: first laser light having a wavelength equal to or larger than 800 nm and equal to or smaller than 1200 nm; and second laser light having a wavelength equal to or smaller than 550 nm.

### BRIEF DESCRIPTION OF THE DRAWINGS

FIG. 1 is an exemplary and schematic configuration diagram of a laser welding device according to a first embodiment;

FIG. 2 is an exemplary and schematic diagram illustrating a beam (spot) of laser light formed on a surface of a processing object by the laser welding device according to the first embodiment;

FIG. 3 is a graph illustrating a light absorption rate of each metallic material with respect to a wavelength of emitted laser light;

FIG. 4 is an exemplary and schematic cross-sectional view of a weld part according to the embodiment;

FIG. 5 is an exemplary and schematic cross-sectional view illustrating part of the weld part according to the embodiment;

FIG. 6 is a graph illustrating an experiment result of welding with a combination of power density of first laser light and power density of second laser light performed by the laser welding device according to the first embodiment;

FIG. 7 is a graph illustrating an experiment result of welding with a combination of a width of the weld part and a second spot diameter in a case of singly emitting first laser light by the laser welding device according to the first embodiment;

FIG. 8 is a graph illustrating a correlation between a spatter suppression rate and an output ratio of power of the second laser light to power of the first laser light of the laser welding device according to the embodiment;

FIG. 9 is an exemplary and schematic cross-sectional view of the weld part according to the embodiment, and is a cross-sectional view at a cross section that is along a sweeping direction and orthogonal to a surface;

FIG. 10 is an exemplary and schematic cross-sectional view of the weld part that is formed by singly emitting the first laser light with the same power as that in the case of FIG. 9 as a reference example, and is a cross-sectional view at a cross section that is along the sweeping direction and orthogonal to the surface;

FIG. 11 is a partially enlarged view of FIG. 9;

FIG. 12 is an explanatory diagram illustrating a case of applying a first reference line to one position in a cross section of the weld part according to the embodiment;

FIG. 13 is an explanatory diagram illustrating a case of applying a second reference line to one position in the cross section of the weld part according to the embodiment;

FIG. 14 is an exemplary and schematic configuration diagram of a laser welding device according to a second embodiment;

FIG. 15 is an explanatory diagram illustrating a concept of a principle of a diffractive optical element included in the laser welding device according to the second embodiment;

FIG. 16 is an exemplary and schematic configuration diagram of a laser welding device according to a third embodiment;

FIG. 17 is an exemplary and schematic configuration diagram of a laser welding device according to a fourth embodiment;

FIG. 18 is an exemplary and schematic configuration diagram of a laser welding system according to a fifth embodiment;

FIG. 19 is an exemplary and schematic configuration diagram of a laser welding system according to a sixth embodiment;

FIG. 20 is an exemplary and schematic configuration diagram of a laser welding system according to a seventh embodiment;

FIG. 21 is a schematic diagram illustrating an example of a beam (spot) of laser light formed on a surface of a processing object by the laser welding device according to the seventh embodiment;

FIG. 22 is a schematic diagram illustrating an example of a beam (spot) of laser light formed on a surface of a processing object by the laser welding device according to the seventh embodiment;

FIG. 23 is a schematic diagram illustrating an example of a beam (spot) of laser light formed on a surface of a processing object by the laser welding device according to the seventh embodiment;

FIG. 24 is an exemplary and schematic configuration diagram of a laser welding device according to an eighth embodiment;

FIG. 25 is an exemplary and schematic configuration diagram of a laser welding device according to a ninth embodiment;

FIG. 26 is a schematic diagram illustrating an example of a beam (spot) of laser light formed on a surface of a processing object by the laser welding device according to the embodiment;

FIG. 27 is an exemplary and schematic cross-sectional view at a cross section that is along a sweeping direction of a weld part according to the embodiment and orthogonal to a surface, and is a cross-sectional view of a front end part in the sweeping direction of the weld part; and

FIG. 28 is an exemplary and schematic cross-sectional view at a cross section that is orthogonal to a surface and along a sweeping direction of a weld part formed by singly emitting first laser light with the same power as that in the case of FIG. 27 as a reference example, and is a cross-sectional view of a front end part in the sweeping direction of the weld part.

### DETAILED DESCRIPTION

The following discloses exemplary embodiments. Configurations in the following embodiments, and an operation and a result (effect) exhibited by the configurations are merely examples. The present disclosure may also be implemented by configurations other than the configurations disclosed in the following embodiments. According to the present disclosure, it is possible to obtain at least one of various effects (including derivative effects) that are obtained by the configurations.

The embodiments described below include the same configurations. Thus, with the configurations according to the respective embodiments, the same operation and effect based on the same configurations may be obtained. Hereinafter, the same configuration is denoted by the same reference numeral, and redundant description will not be repeated in some cases.

In the respective drawings, an X-direction is represented by an arrow X, a Y-direction is represented by an arrow Y, and a Z-direction is represented by an arrow Z. The X-direction, the Y-direction, and the Z-direction intersect with and are orthogonal to each other. The Z-direction is a normal direction of a surface Wa (processing surface) of a processing object W.

In the present specification, ordinal numbers are added for convenience′ sake to distinguish components, members, parts, pieces of laser light, directions, and the like from each other, and do not represent priority or order.

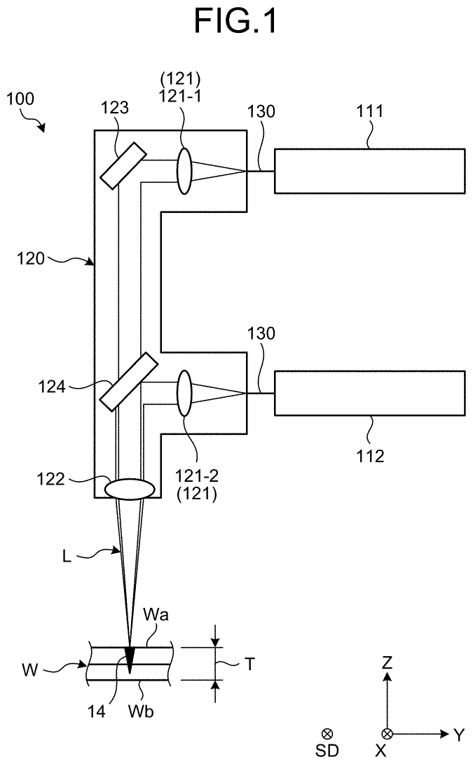

FIG. 1 is a schematic configuration diagram of a laser welding device 100 according to a first embodiment. As illustrated in FIG. 1, the laser welding device 100 includes a laser device 111, a laser device 112, an optical head 120, and optical fibers 130.

Each of the laser devices 111 and 112 includes a laser oscillator, and is configured to be able to output laser light having power of several kilowatts, for example. Each of the laser devices 111 and 112 may include a plurality of semiconductor laser elements inside, for example, and may be configured to be able to output multi-mode laser light having power of several kilowatts as a total output of the semiconductor laser elements. Furthermore, each of the laser devices 111 and 112 may include various laser light sources such as a fiber laser, a YAG laser, and a disk laser.

The laser device 111 outputs first laser light having a wavelength equal to or larger than 800 nm and equal to or smaller than 1200 nm. The laser device 111 is an example of a first laser device. The laser oscillator included in the laser device 111 is an example of a first laser oscillator.

On the other hand, the laser device 112 outputs second laser light having a wavelength equal to or smaller than 500 nm. The laser device 112 is an example of a second laser device. The laser device 112 preferably outputs the second laser light having a wavelength equal to or larger than 400 nm and equal to or smaller than 500 nm. The laser oscillator included in the laser device 112 is an example of a second laser oscillator.

The optical fibers 130 respectively guide pieces of laser light output from the laser devices 111 and 112 to the optical head 120.

The optical head 120 is an optical device for emitting the laser light input from the laser devices 111 and 112 to the processing object W. The optical head 120 includes collimating lenses 121, a condensing lens 122, a mirror 123, and a filter 124. The collimating lenses 121, the condensing lens 122, the mirror 123, and the filter 124 may also be referred to as optical components.

The optical head 120 is configured to be able to change a relative position with respect to the processing object W for sweeping laser light L while emitting the laser light L on the surface Wa of the processing object W. Relative movement of the optical head 120 and the processing object W may be implemented by movement of the optical head 120, movement of the processing object W, or movement of both of the optical head 120 and the processing object W.

The optical head 120 may also be configured to be able to sweep the laser light L on the surface Wa by including a galvanoscanner and the like (not illustrated).

Each of the collimating lenses 121 (121-1, 121-2) collimates the laser light input via the optical fiber 130. The collimated laser light becomes collimated light.

The mirror 123 reflects the first laser light that has become the collimated light through the collimating lens 121-1. The first laser light reflected by the mirror 123 travels in a direction opposite to the Z-direction, and travels toward the filter 124. In a configuration in which the first laser light is input to travel in the direction opposite to the Z-direction in the optical head 120, the mirror 123 is not required.

The filter 124 is a high-pass filter that transmits the first laser light, and does not transmit but reflects the second laser light. The first laser light is transmitted through the filter 124 to travel in the direction opposite to the Z-direction, and travels toward the condensing lens 122. On the other hand, the filter 124 reflects the second laser light that has become the collimated light through the collimating lens 121-2. The second laser light reflected by the filter 124 travels in the direction opposite to the Z-direction, and travels toward the condensing lens 122.

The condensing lens 122 condenses the first laser light and the second laser light as the collimated light, and emits the first laser light and the second laser light to the processing object W as the laser light L (output light). The processing object W is an example of a metallic member.

When the laser light L is emitted, a weld part 14 is formed on the processing object W. The weld part 14 extends from the surface Wa toward a back surface Wb, and linearly extends in a sweeping direction SD along the surface Wa. The surface Wa is an example of a first surface, and the back surface Wb is an example of a second surface.

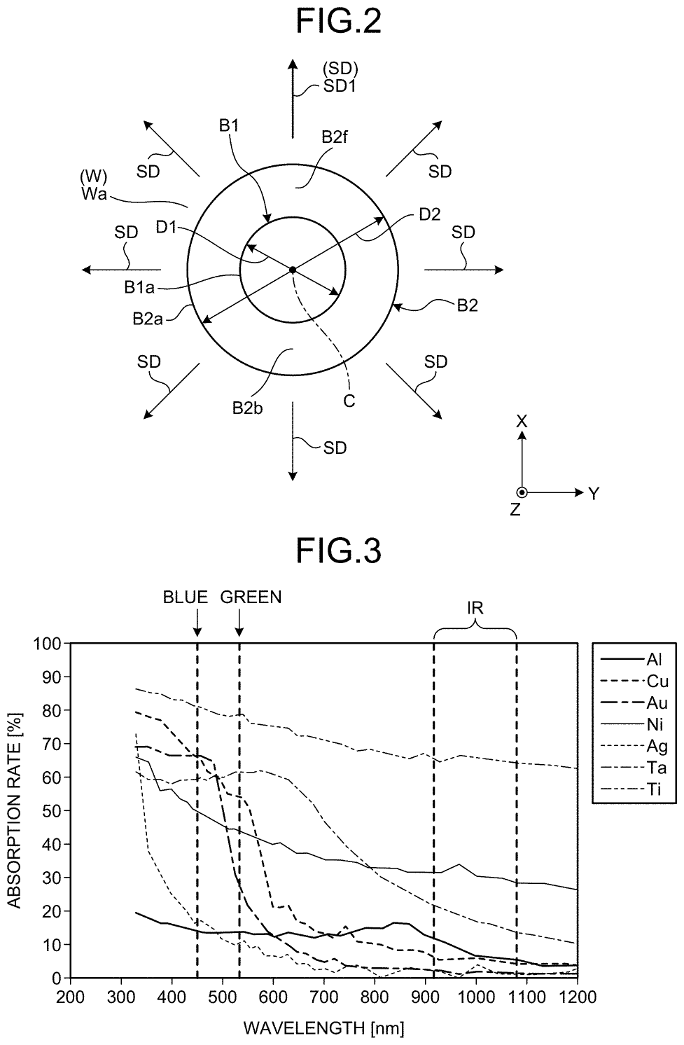

FIG. 2 is a schematic diagram illustrating a beam (spot) of the laser light L emitted onto the surface Wa of the processing object W. As illustrated in FIG. 2, on the surface Wa, the beam of the laser light L is formed such that a beam B1 of the first laser light overlaps a beam B2 of the second laser light, the beam B2 is larger (wider) than the beam B1, and an outer edge B2a of the beam B2 surrounds an outer edge B1a of the beam B1. On the surface Wa, the beam B1 is an example of a first spot, and the beam B2 is an example of a second spot.

The arrow SD illustrated in FIG. 2 indicates the sweeping direction. As illustrated in FIG. 2, the beam of the laser light L has a point symmetrical shape with respect to a center point C, so that the shapes of beams (spots) of the laser light L become the same with respect to the optional sweeping direction SD. Thus, in a case of including a moving mechanism that moves the optical head 120 and the processing object W relatively to each other for sweeping the laser light L on the surface Wa, the moving mechanism may include at least a relatively translatable mechanism, and a relatively rotatable mechanism is not necessarily provided in some cases.

Each processing object W may be made of a metallic material having relatively high thermal conductivity. Examples of the metallic material include a copper-based metallic material, an aluminum-based metallic material, a nickel-based metallic material, an iron-based metallic material, and a titanium-based metallic material. Specifically, the metallic material is copper, a copper alloy, aluminum, an aluminum alloy, tin, nickel, a nickel alloy, iron, stainless steel, titanium, a titanium alloy, and the like. The processing object W is an example of a metallic member.

The following describes a light absorption rate of the metallic material. FIG. 3 is a graph indicating the light absorption rate of each metallic material with respect to a wavelength of the emitted laser light L. A horizontal axis of the graph in FIG. 3 indicates the wavelength, and a vertical axis indicates the absorption rate. FIG. 3 illustrates a relation between the wavelength and the absorption rate regarding aluminum (Al), copper (Cu), gold (Au), nickel (Ni), silver (Ag), tantalum (Ta), and titanium (Ti).

Although respective materials have different characteristics, regarding metals illustrated in FIG. 3, it may be understood that an absorption rate of energy becomes higher by using blue or green laser light (second laser light) rather than using typical laser light (first laser light) of infrared rays (IR). This characteristic is conspicuous with copper (Cu), gold (Au), and the like.

In a case in which the laser light is emitted onto the processing object W having a relatively low absorption rate with respect to a used wavelength, most of light energy is reflected and does not affect the processing object W as heat. Thus, relatively high power needs to be applied for obtaining a melting region having a sufficient depth. In this case, energy is abruptly input to a beam center part, so that sublimation is caused, and a keyhole is formed.

On the other hand, in a case in which the laser light is emitted onto the processing object W having a relatively high absorption rate with respect to the used wavelength, most of the input energy is absorbed by the processing object W to be converted into thermal energy. That is, excessive power is not required to be applied, so that a keyhole is not formed, and melting of thermal conductive type is performed.

In the present embodiment, the wavelength of the first laser light, the wavelength of the second laser light, and the material of the processing object W are selected so that the absorption rate of the processing object W for the second laser light is higher than the absorption rate for the first laser light. In this case, in a case in which the sweeping direction is a sweeping direction SD1 in FIG. 2, first, the second laser light is emitted onto a part to be welded of the processing object W (hereinafter, referred to as a part to be welded) by a region B2f positioned on a forward side of SD in FIG. 2 of the beam B2 of the second laser light by sweeping the spot of the laser light L. Thereafter, the beam B1 of the first laser light is emitted onto the part to be welded, and subsequently, the second laser light is emitted thereto again by a region B2b positioned on a rearward side of the sweeping direction SD1 of the beam B2 of the second laser light.

Thus, first, a melting region of thermal conductive type is generated at the part to be welded by emission of the second laser light having a high absorption rate in the region B2f. Thereafter, a deeper melting region of keyhole type is generated at the part to be welded by emission of the first laser light. In this case, the melting region of thermal conductive type is previously formed at the part to be welded, so that a melting region having a required depth may be formed with the first laser light having lower power as compared with a case in which the melting region of thermal conductive type is not formed. Furthermore, subsequently, the melting state is changed at the part to be welded by emission of the second laser light having a high absorption rate in the region B2b. From such a point of view, the wavelength of the second laser light is preferably equal to or smaller than 550 nm, and more preferably equal to or smaller than 500 nm.

Through experimental researches carried out by the present inventors, it has been confirmed that a welding defect may be reduced in welding performed by emitting the laser light L of the beam as illustrated in FIG. 2. It may be estimated that this is because a molten pool of the processing object W formed by the beam B2 and the beam B1 is more stabilized by preheating the processing object W by the region B2f of the beam B2 before the beam B1 arrives.

In welding performed by using the laser welding device 100, first, the processing object W is set so that the laser light L is emitted onto the surface Wa of the processing object W. The laser light L and the processing object W are relatively moved in a state in which the laser light L including the beam B1 and the beam B2 is emitted onto the surface Wa. Due to this, the laser light L is moved (swept) in the sweeping direction SD on the surface Wa while being emitted onto the surface Wa. A portion to which the laser light L is emitted is molten, and solidified thereafter along with lowering of a temperature. Accordingly, the processing object W is welded.

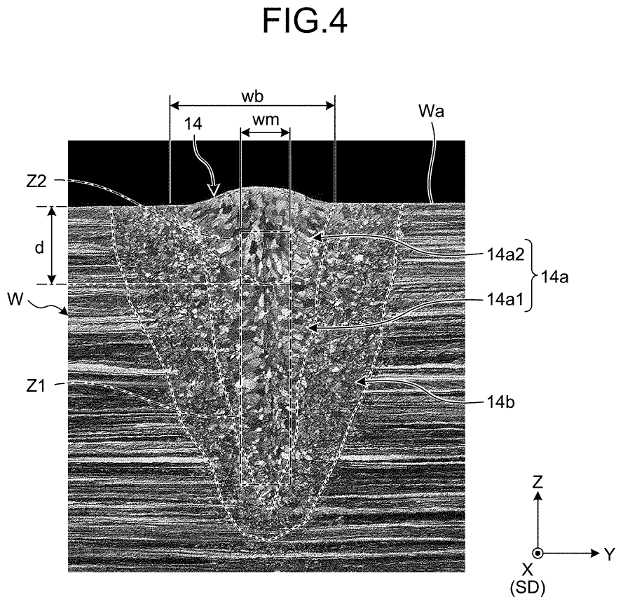

FIG. 4 is a cross-sectional view of the weld part 14 formed on the processing object W. FIG. 4 is a cross-sectional view that is perpendicular to the sweeping direction SD (X-direction) and along the thickness direction (Z-direction). The weld part 14 extends in the sweeping direction SD, that is, a direction perpendicular to a sheet surface of FIG. 4. FIG. 4 illustrates a cross section of the weld part 14 formed on the processing object W as one copper plate having a thickness of 2 [mm]. It may be estimated that a form of the weld part 14 formed on a plurality of plate-shaped metallic materials overlapped in the thickness direction (Z-direction) is substantially equivalent to a form of a weld part formed on one metallic material having the same thickness.

As illustrated in FIG. 4, the weld part 14 includes a weld metal 14a extending from the surface Wa in the direction opposite to the Z-direction, and a heat affected part 14b positioned around the weld metal 14a. The weld metal 14a is a part that is molten by emission of the laser light L and solidified thereafter. The weld metal 14a may also be referred to as a molten and solidified part. The heat affected part 14b is a part where a preform of the processing object W is affected by heat, which is not molten.

The width along the Y-direction of the weld metal 14a becomes narrower as being more distant from the surface Wa. That is, a cross section of the weld metal 14a has a tapered shape that is tapered toward the direction opposite to the Z-direction.

Additionally, through detailed analysis of the cross section performed by the present inventors, it has been found that the weld metal 14a includes a first part 14a1 distant from the surface Wa and a second part 14a2 between the first part 14a1 and the surface Wa.

The first part 14a1 is a part obtained by melting of keyhole type performed by emission of the first laser light, and the second part 14a2 is a part obtained by melting performed by emission of the region B2b positioned on the rearward side of the sweeping direction SD1 in the beam B2 of the second laser light. Through analysis by an EBSD method (electron back scattered diffraction pattern), it has been found that sizes of crystal grains are different between the first part 14a1 and the second part 14a2, specifically, an average value of cross-sectional areas of crystal grains in the second part 14a2 is larger than an average value of cross-sectional areas of crystal grains in the first part 14a1 on a cross section orthogonal to the X-direction (sweeping direction SD).

The present inventors have confirmed that, in a case in which only the beam B1 of the first laser light is emitted onto the part to be welded, that is, in a case in which the region B2b positioned on the rearward side of the sweeping direction SD1 in the beam B2 is not emitted thereto, the second part 14a2 is not formed, and the first part 14a1 deeply extends from the surface Wa in the direction opposite to the Z-direction. That is, in the present embodiment, the second part 14a2 is formed in the vicinity of the surface Wa by emitting the region B2b positioned on the rearward side of the sweeping direction SD1 in the beam B2, so that it may be estimated that the first part 14a1 is formed on the opposite side of the surface Wa across the second part 14a2, in other words, formed at a position separated away from the surface Wa in the direction opposite to the Z-direction.

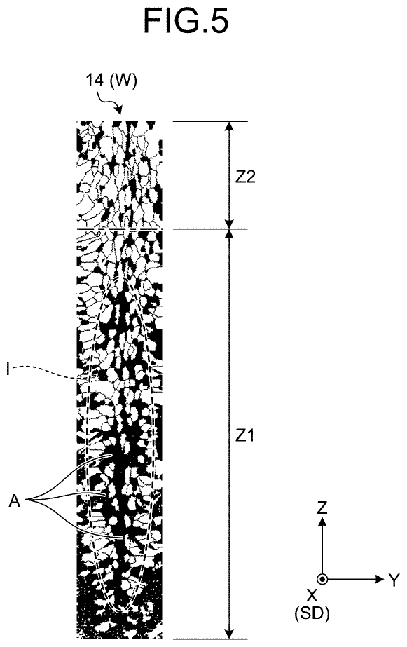

FIG. 5 is a cross-sectional view illustrating part of the weld part 14. FIG. 5 illustrates boundaries of the crystal grains obtained by the EBSD method. In FIG. 5, by way of example, crystal grains A each having a crystal grain diameter equal to or smaller than 13 μm are colored in black. Herein, 13 μm is not a threshold of a physical characteristic but a threshold set for analysis of an experiment result. With reference to FIG. 5, it is obvious that a relatively large number of the crystal grains A are present in the first part 14a1, and a relatively small number of the crystal grains A are present in the second part 14a2. That is, the average value of the cross-sectional areas of the crystal grains in the second part 14a2 is larger than the average value of the cross-sectional areas of the crystal grains in the first part 14a1. Through experimental analysis, the present inventors have confirmed that the average value of the cross-sectional areas of the crystal grains in the second part 14a2 is 1.8 times or more the average value of the cross-sectional areas of the crystal grains in the first part 14a1.

As illustrated in a region I in FIG. 5, the crystal grains A each having a relatively small size are densely present in a state of extending in an elongated shape in the Z-direction at a position distant from the surface Wa in the Z-direction. Through analysis at a plurality of points the positions of which in the X-direction (sweeping direction SD) are different, it has been confirmed that the region in which the crystal grains A are densely present extends also in the sweeping direction SD. Welding is performed while performing sweeping, so that it may be estimated that the crystals are formed in the same form in the sweeping direction SD.

In a case in which the first part 14a1 and the second part 14a2 are difficult to be discriminated from each other based on external appearances, hardness distribution, and the like on the cross section, a first region Z1 and a second region Z2 may be respectively assumed to be the first part 14a1 and the second part 14a2, the first region Z1 and the second region Z2 that are geometrically determined based on a position and a width wb of the weld metal 14a on the surface Wa as illustrated in FIGS. 4 and 5. By way of example, the first region Z1 and the second region Z2 are quadrangular regions having a width wm (fixed width in the Y-direction) and extending in the Z-direction on the cross section orthogonal to the sweeping direction SD, the second region Z2 may be a region having a depth d from the surface Wa in the Z-direction, and the first region Z1 may be a region deeper than the depth d, in other words, a region opposite to the surface Wa with respect to the position of the depth d. The width wm may be, for example, ⅓ of the width wb (an average value of a bead width) on the surface Wa of the weld metal 14a, and the depth d (height, thickness) of the second region Z2 may be, for example, ½ of the width wb. A depth of the first region Z1 may be, for example, three times the depth d of the second region Z2. Through experimental analysis of a plurality of samples, the present inventors have confirmed that the average value of the cross-sectional areas of the crystal grains in the second region Z2 is larger than and 1.8 times or more the average value of the cross-sectional areas of the crystal grains in the first region Z1 with such setting of the first region Z1 and the second region Z2. It may be considered that such a relation between the sizes of the crystal grains in the first region Z1 and the second region Z2 is a factor for implementing firm welding strength for the processing object W, and such discrimination may become evidence for the fact that the first part 14a1 and the second part 14a2 are formed in the weld metal 14a by welding.

Through experimental researches carried out by the present inventors, it has been found that the same result may be obtained in a case in which a thickness T (refer to FIG. 1) of the processing object W of laser welding according to the present embodiment is equal to or larger than 0.05 [mm] and equal to or smaller than 2.0 [mm].

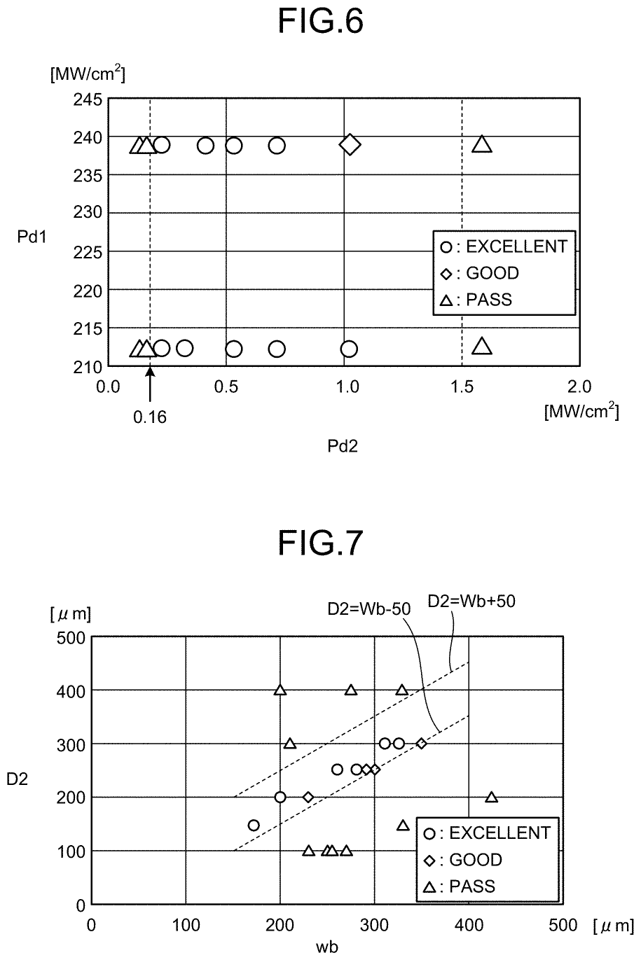

FIG. 6 is a graph illustrating an experiment result of welding with a combination of power density Pd1 of the first laser light and power density Pd2 of the second laser light on the surface Wa of the processing object W. In FIG. 6, “∘ (circle)” represents a case in which the number of spatters and blow holes is very small (excellent), “⋄ (rhombus)” represents a case in which the number of spatters and blow holes is small (good), and Δ (triangle) represents a case in which, although the number of spatters and blow holes is small, some other disadvantages are caused such that energy loss is large, for example (pass). Herein, by way of example, “excellent” represents a case in which the number of blow holes per unit length (for example, 1 [cm]) of a linear weld part is equal to or smaller than 1, and “good” and “pass” represent a case in which the number of blow holes per unit length of the weld part is equal to or larger than 2 and smaller than 5. In this experiment, a wavelength of the first laser light was 1070 nm, an output thereof was 1.5 [kW], a wavelength of the second laser light was 450 nm, and an output thereof was 150 [W].

Based on FIG. 6, it has been found that the number of spatters and the number of blow holes may be suppressed in a case in which the power density Pd2 of the second laser light is equal to or larger than 0.16 [MW/cm²] and equal to or smaller than 1.5 [MW/cm²]. It may be considered that this is because a light energy amount absorbed by a copper plate surface is insufficient and a preheating effect may not be sufficiently obtained in a case in which the power density Pd2 of the second laser light is lower than 0.16 [MW/cm²] (lower limit value), and in a case in which the power density Pd2 is higher than 1.5 [MW/cm²] (upper limit value), melting of keyhole type is performed with the second laser light.

Each of the beam B1 and the beam B2 has, for example, Gaussian-shaped power distribution in a radial direction of a cross section orthogonal to an optical axis direction of the beam. However, the power distribution of the beam B1 and the beam B2 is not limited to the Gaussian shape. In each of the drawings representing each of the beams B1 and B2 by a circle like FIG. 2, a diameter of the circle representing each of the beams B1 and B2 is a beam diameter of each of the beams B1 and B2. The beam diameter of each of the beams B1 and B2 includes a peak of the beam, and defined as a diameter of a region having an intensity of 1/e² or more of peak intensity. Although not illustrated, in a case of a beam not having a circular shape, it is possible to define, as the beam diameter, a length of a region having an intensity of 1/e² or more of the peak intensity in a direction perpendicular to the sweeping direction SD. The beam diameter on the surface Wa of the processing object W is referred to as a spot diameter.

FIG. 7 is a diagram illustrating an experiment result of welding with a combination of the width wb (bead width) of the weld part and a spot diameter D2 (outer diameter, refer to FIG. 2) of the beam B2 at the time of singly emitting the beam B1. Meanings and standards of symbols (∘ (circle), ⋄ (rhombus), Δ (triangle)) in FIG. 7 are the same as those in FIG. 6. In this experiment, a wavelength of the first laser light was 1070 nm, an output thereof was 1 [kW], a wavelength of the second laser light was 450 nm, and an output thereof was 400 [W].

Through experimental researches carried out by the present inventors, it has been found that the number of spatters may be suppressed in a case in which the width wb of the weld part and the spot diameter D2 at the time of singly emitting the beam B1 have a predetermined relation, that is, the following expression (1) is satisfied: wb−400<D2<wb+400 . . . (1).

Furthermore, it has been found that the number of spatters may be suppressed without causing other disadvantages such as increase in energy loss in a case in which the following expression (1A) is satisfied: wb−50<D2<wb+50 . . . (1A).

Suppression of spatters based on output ratio of first laser light and second laser light

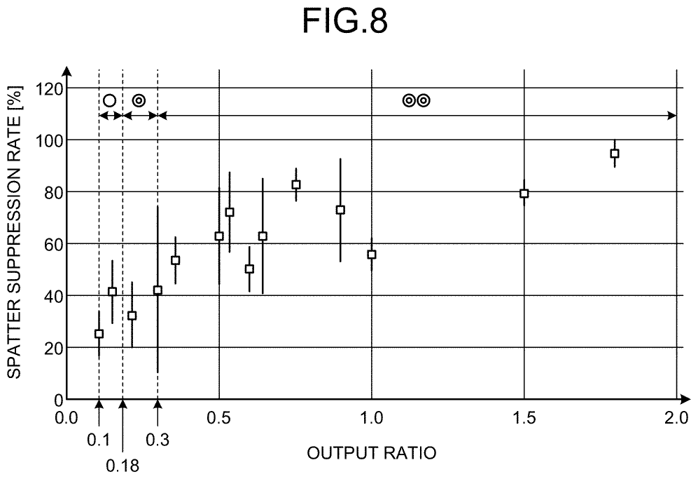

FIG. 8 is a graph illustrating a correlation between a spatter suppression rate and an output ratio (Rp=Pw2/Pw1) of power (Pw2) of the second laser light to power (Pw1) of the first laser light. Herein, a spatter suppression rate Rs is defined as represented by the following expression (2).

Rs=1−Nh/Nir (2)

Herein, Nh is the number of spatters generated in a predetermined area in a case of emitting both of the first laser light and the second laser light, and Nir is the number of spatters generated in the predetermined area in a case of emitting only the first laser light with the same power as that at the time of measuring Nh. FIG. 8 illustrates results of a plurality of experiments performed at respective output ratios. A line segment corresponding to the output ratio indicates a range of variation of the spatter suppression rate in experiment results of a plurality of samples (at least three or more samples) at the output ratio, and □ (square) indicates a median of the spatter suppression rate for each output ratio.

As illustrated in FIG. 8, through experimental researches carried out by the present inventors, it has been found that the output ratio Rp is preferably equal to or larger than 0.1 and smaller than 0.18 (∘), more preferably equal to or larger than 0.18 and smaller than 0.3 (⊚ (double circle)), and even more preferably equal to or larger than 0.3 and equal to or smaller than 2 (⊚⊚ (two double circles)).

The present inventors have carried out experiments for a plurality of samples at different sweeping speeds, and found that generation states of spatters and blow holes are different depending on the sweeping speed. Specifically, from a viewpoint of reducing the number of spatters or blow holes to be generated, it has been found that the sweeping speed is preferably equal to or higher than 50 mm/s, and more preferably equal to or higher than 100 mm/s.

Through experimental researches carried out by the present inventors, it has been found that the number of voids (blow holes) generated on the weld part 14 is reduced in welding performed by emitting both of the first laser light and the second laser light as compared with welding performed by singly emitting the first laser light.

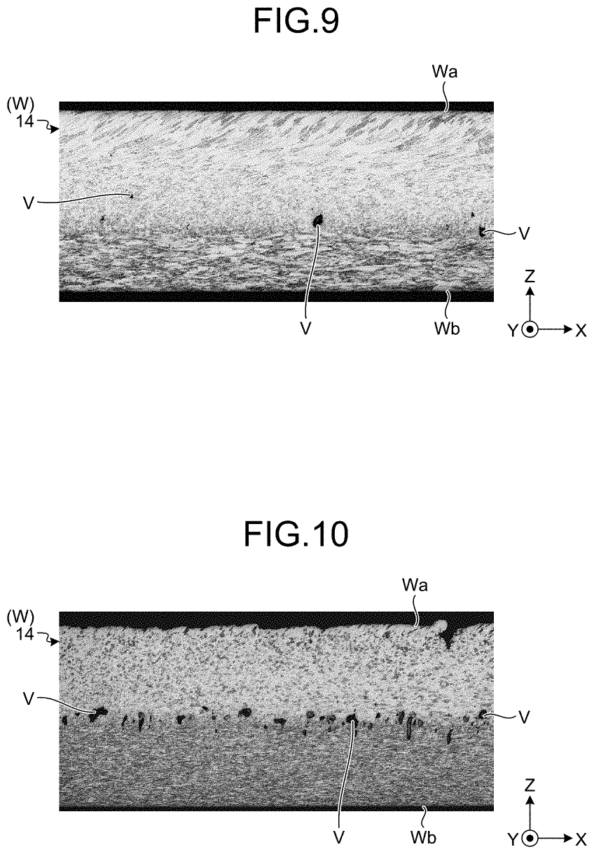

FIG. 9 is a cross-sectional view of the weld part 14 formed by emitting both of the first laser light and the second laser light at a cross section that is along the sweeping direction and orthogonal to the surface Wa. FIG. 10 is a cross-sectional view of the weld part 14 formed by singly emitting the first laser light with the same power as that in the case of FIG. 9 as a reference example at a cross section that is along the sweeping direction and orthogonal to the surface Wa. Conditions for the example in FIG. 10 other than the condition that the first laser light is singly emitted are set to be the same as those in the example of FIG. 9.

Comparing FIG. 9 with FIG. 10, it is obvious that the number of voids V generated on the weld part 14 is reduced in welding performed by emitting both of the first laser light and the second laser light (FIG. 9) as compared with welding performed by singly emitting the first laser light (FIG. 10).

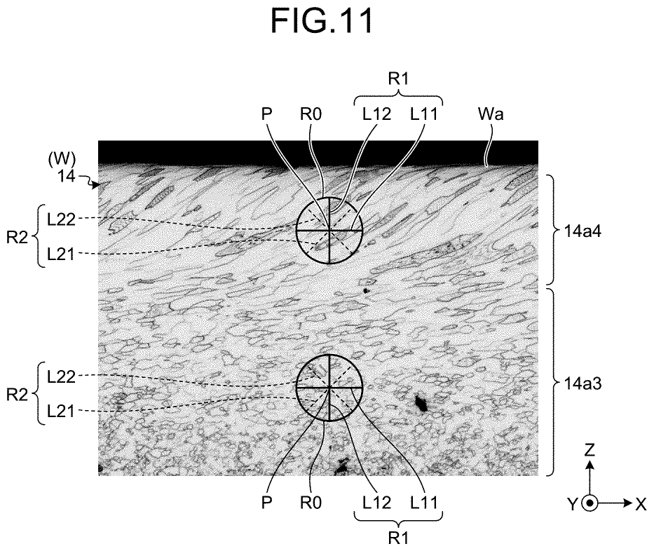

FIG. 11 is an enlarged view of part of FIG. 9. Through experimental researches carried out by the present inventors, as illustrated in FIG. 11, it has been found that orientation (a longitudinal direction, a growth direction) of the crystal grain varies depending on the depth from the surface Wa at the weld part 14 that is formed by emitting both of the first laser light and the second laser light. This may be because a growth state of the crystal grain at the time of solidification is different between a third part 14a3 obtained by melting of keyhole type performed by emission of the first laser light and a fourth part 14a4 obtained by melting performed by emission of the region B2b positioned on the rearward side of the sweeping direction in the beam B2 of the second laser light. Herein, the third part 14a3 is a part positioned to be distant from the surface Wa, and a part corresponding to the first part 14a1 described above. The fourth part 14a4 is a part positioned between the third part 14a3 and the surface Wa, and is a part corresponding to the second part 14a2 described above.

To represent such a configuration by numerical values, the present inventors have defined an indicator representing the orientation (longitudinal direction) of the crystal grain at each part within the weld part 14 conforming to JIS G 0551: 2020, A.2: cutting method.

Specifically, as illustrated in FIG. 11, two types of a first reference line R1 and a second reference line R2 including two straight test lines orthogonal to each other are used in an image of the cross section. In FIG. 11, the first reference line R1 is indicated by a solid line, and the second reference line R2 is indicated by a dashed line. The first reference line R1 includes, as straight test lines L11 and L12, two diameters orthogonal to each other of a reference circle R0. The straight test line L11 extends in the X-direction (sweeping direction) along the surface Wa, and the straight test line L12 extends in the Z-direction orthogonal to the surface Wa. The second reference line R2 includes, as straight test lines L21 and L22, two diameters orthogonal to each other of the same reference circle R0 as that of the first reference line R1. The straight test line L21 extends in a direction between the X-direction and the Z-direction, and the straight test line L22 extends in a direction between a direction opposite to the X-direction and the Z-direction, or a direction between the direction opposite to the Z-direction and the X-direction. An angle difference between the straight test line L11 and the straight test line L21 is 45° or 135°, and an angle difference between the straight test line L12 and the straight test line L22 is 45° or 135°. A length of the diameter of the reference circle R0, that is, each of lengths of the straight test lines L11, L12, L21, and L22 is a length corresponding to 200 μm (an example of a predetermined length), by way of example, but may be appropriately set corresponding to the size of the crystal grain.

By applying the first reference line R1 and the second reference line R2 to each point P in the weld part 14, a first ratio Rb1 of the number of grain boundaries and a second ratio Rb2 of the number of grain boundaries are obtained by the following expressions (3-1) and (3-2).

Rb1=N12/N11 (3-1)

Rb2=max(N22/N21,N21/N22) (3-2)

Herein, N11 is the number of crystal grains intersecting with the straight test line L11, and N12 is the number of crystal grains intersecting with the straight test line L12. N21 is the number of crystal grains intersecting with the straight test line L21, and N22 is the number of crystal grains intersecting with the straight test line L22. The number of crystal grains may also be referred to as the number of grain boundaries. In the expression (3-2), max(N22/N21, N21/N22) is (N22/N21) in a case in which (N22/N21) is equal to or larger than (N21/N22), and max(N22/N21, N21/N22) is (N21/N22) in a case in which (N22/N21) is smaller than (N21/N22). In actual measurement, the measurement described above may be performed at optional predetermined points or more, for example, at ten or more points in a microphotograph of an X-Z cross section photographed at 50-fold magnification, and average values thereof may be assumed to be Rb1 and Rb2. In a case in which any of N11, N12, N21, and N22 is 0 at a certain point P in the weld part 14, the number of grain boundaries at this point P is not required to be used for calculating Rb1 and Rb2.

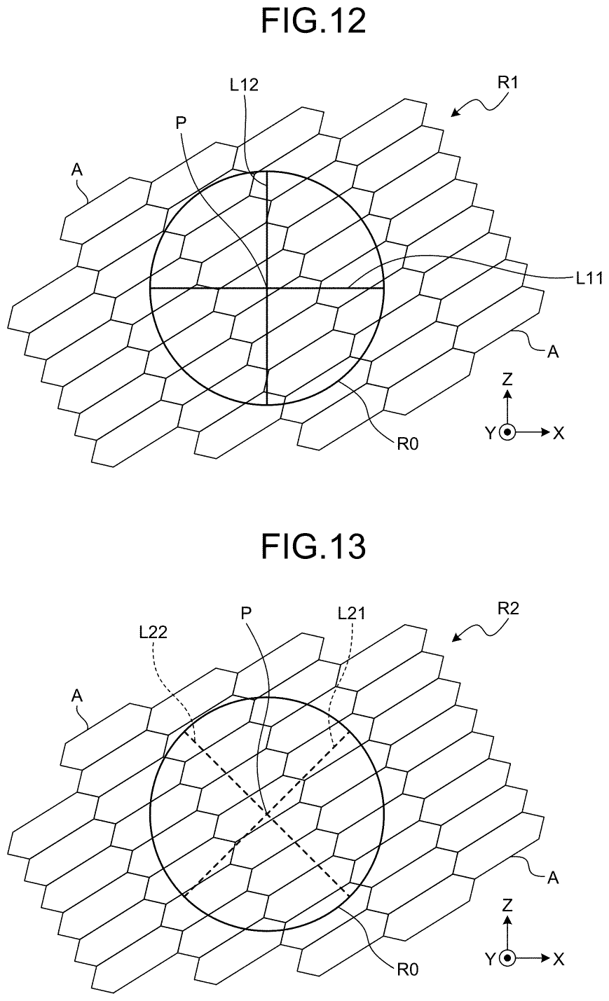

FIGS. 12 and 13 are schematic explanatory diagrams illustrating a case of applying the first reference line R1 to one point P within the cross section of the weld part 14 (FIG. 12), and a case of applying the second reference line R2 thereto (FIG. 13). As illustrated in FIGS. 12 and 13, the numbers of crystal grains A (grain boundaries) intersecting with the respective straight test lines L11, L12, L21, and L22 are different from each other. In the examples of FIGS. 12 and 13, an angle difference between the straight test line L21 and the crystal grains A is relatively small, so that the number of grain boundaries N21 becomes smaller than the other numbers of grain boundaries N11, N12, and N22. Thus, the point P illustrated in the examples of FIGS. 12 and 13 is the point P at which the second ratio Rb2 of the number of grain boundaries is higher than the first ratio Rb1 of the number of grain boundaries. Similarly, in the definition described above, at the point P at which an angle difference between the longitudinal direction of the crystal grains A and the X-direction is relatively small in the reference circle R0, the first ratio Rb1 of the number of grain boundaries becomes relatively high and higher than the second ratio Rb2 of the number of grain boundaries. At the point P at which an angle difference between the longitudinal direction of the crystal grains A and the direction between the X-direction and the Z-direction (45° direction) is relatively small, the second ratio Rb2 of the number of grain boundaries becomes relatively high and higher than the first ratio Rb1 of the number of grain boundaries.

Through experimental researches carried out by the present inventors, it has been found that the first ratio Rb1 of the number of grain boundaries at each point P in the fourth part 14a4 is lower than the first ratio Rb1 of the number of grain boundaries at each point P in the third part 14a3. Additionally, it has been found that the second ratio Rb2 of the number of grain boundaries at each point P in the fourth part 14a4 is higher than the second ratio Rb2 of the number of grain boundaries at each point in the third part 14a3. Furthermore, it has been found that the first ratio Rb1 of the number of grain boundaries is higher than the second ratio Rb2 of the number of grain boundaries at each point P in the third part 14a3, and the second ratio Rb2 of the number of grain boundaries is higher than the first ratio Rb1 of the number of grain boundaries at each point P in the fourth part 14a4. It may be considered that the presence of such parts at which the first ratio Rb1 of the number of grain boundaries and the second ratio Rb2 of the number of grain boundaries are different in the weld part 14 is a factor for implementing firm welding strength for the processing object W, and may become evidence for the fact that welding is performed by emitting both of the first laser light and the second laser light.

Through experimental researches carried out by the present inventors, it has been found that, in welding performed by emitting the first laser light and the second laser light by the laser welding device 100 according to the present embodiment, a favorable result (corresponding to “excellent” described above) may be obtained even in a case in which arithmetic average roughness Ra of the surface Wa of the processing object W is equal to or smaller than 21 μm. This experiment was performed for respective cases in which the arithmetic average roughness Ra is 21 μm, 8 μm, and 6 μm, and favorable results were obtained for all of the cases. With a known laser welding device, in a case in which the surface Wa is close to a mirror plane, for example, laser light may be reflected from the surface Wa, and welding may be hardly performed or may not be performed. In this point of view, according to the present embodiment, laser light is more efficiently absorbed by the surface Wa, so that more favorable welding may be performed with laser light having lower power on the processing object W having the surface Wa close to a mirror plane the arithmetic average roughness Ra of which is equal to or smaller than 21 μm, or further lower to be 8 μm or 6 μm.

As described above, in the welding method according to the present embodiment, for example, welding is performed on the processing object W by emitting the laser light L onto the surface Wa so that the spot relatively moves along the surface Wa. The laser light L includes the first laser light having a wavelength equal to or larger than 800 nm and equal to or smaller than 1200 nm, and the second laser light having a wavelength equal to or smaller than 550 nm.

The wavelength of the second laser light is preferably equal to or larger than 400 nm and equal to or smaller than 500 nm.

With such a method, for example, higher-quality welding with few welding defects may be performed.

In the present embodiment, for example, on the surface Wa, the beam B2 of the second laser light (second irradiation region) is larger than the beam B1 of the first laser light (first irradiation region), and the outer edge B2a of the beam B2 (second outer edge) surrounds the outer edge B1a of the beam B1 (first outer edge).

With such a method, for example, it is possible to obtain the processing object W including the weld part 14 that includes fewer welding defects and has higher welding quality. Additionally, for example, it is possible to obtain advantages such that the power of the first laser light may be further lowered, or relative rotation of the optical head 120 and the processing object W is not required.

In the present embodiment, for example, the processing object W is made of any of a copper-based metallic material, an aluminum-based metallic material, a nickel-based metallic material, an iron-based metallic material, and a titanium-based metallic material. The metallic material may have electrical conductivity, or does not necessarily have electrical conductivity.

An effect of the welding method according to the present embodiment is obtained in a case in which the processing object W is made of any of the materials described above.

In the present embodiment, for example, on the surface Wa, at least part of the beam B2 of the second laser light (second spot) is positioned on the forward side of the sweeping direction SD as compared with the beam B1 of the first laser light (first spot).

In the present embodiment, for example, the beam B1 and the beam B2 at least partially overlap each other on the surface Wa.

In the present embodiment, for example, the beam B2 is larger than the beam B1 on the surface Wa.

In the present embodiment, for example, on the surface Wa, the outer edge B2a of the beam B2 (second outer edge) surrounds the outer edge B1a of the beam B1 (first outer edge).

In the present embodiment, for example, the spot diameter D2 is set so that the width wb of the weld part at the time of singly emitting the beam B1 and the spot diameter D2 satisfy the following expression (1): wb−400<D2<wb+400 . . . (1).

In the present embodiment, for example, on the surface Wa, an output ratio of the power of the second laser light to the power of the first laser light is equal to or larger than 0.1 and equal to or smaller than 2.

As described above, the present inventors have confirmed that welding defects may be reduced in welding performed by emitting the beam of the laser light L that forms the beams B1 and B2 on the surface Wa. As described above, it may be estimated that this is because a molten pool of the processing object W formed by the beam B2 and the beam B1 is more stabilized by preheating the processing object W by the region B2f of the beam B2 before the beam B1 arrives. Thus, with the laser light L including the beams B1 and B2, for example, it is possible to perform welding including fewer welding defects and having higher welding quality. With such setting of the beams B1 and B2, for example, it is possible to obtain an advantage such that the power of the first laser light may be further lowered. In a case in which the beam B1 and the beam B2 are coaxially emitted, it is possible to obtain an advantage such that relative rotation of the optical head 120 and the processing object W is not required.

The weld metal 14a of the processing object W (metallic member) according to the present embodiment includes the first part 14a1 positioned to be distant from the surface Wa (first surface) in the thickness direction (direction opposite to the Z-direction), and the second part 14a2 disposed between the first part 14a1 and the surface Wa, the second part 14a2 in which the average value of the cross-sectional areas of the crystal grains is larger than that of the first part 14a1.

In the present embodiment, at the cross section orthogonal to an extending direction (the X-direction, the sweeping direction SD) of the weld part 14, the average value of the cross-sectional areas of the crystal grains included in the second part 14a2 is 1.8 times or more the average value of the cross-sectional areas of the crystal grains included in the first part 14a1.

As described above, the weld part 14 is obtained by emitting the beam of the laser light L including the beam B1 of the first laser light and the beam B2 of the second laser light as illustrated in FIG. 2 onto the surface Wa while sweeping the beam in the sweeping direction SD. Additionally, as described above, the present inventors have confirmed by an experiment that welding defects may be reduced in welding performed by emitting the beam of the laser light L as illustrated in FIG. 2. Thus, with the configuration described above, for example, it is possible to obtain the processing object W (metallic member) including the weld part 14 that includes fewer welding defects and has higher welding quality. Furthermore, according to the present embodiment, for example, it is possible to obtain advantages such that the power of the first laser light may be further lowered, or relative rotation of the optical head 120 and the processing object W is not required.

The metallic member as the processing object W may be applied to various electric components, or an electronic appliance including the electric components. The electric component is, for example, a conductor such as a terminal, a bus bar, a coil, or a tab of a battery. For example, the electronic appliance includes the conductor. Specifically, the electronic appliance is a motor, a set battery, an inverter, a computer, or the like.

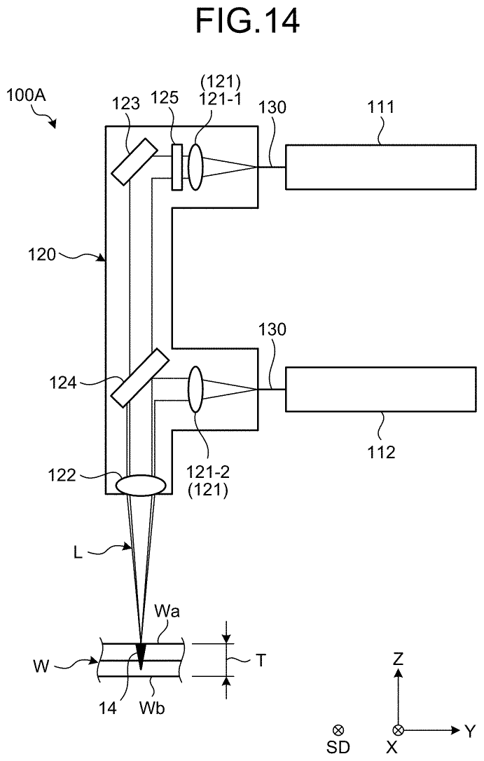

FIG. 14 is a schematic configuration diagram of a laser welding device 100A according to a second embodiment. In the present embodiment, the optical head 120 includes a DOE 125 between the collimating lens 121-1 and the mirror 123. Except for this point, the laser welding device 100A has the same configuration as that of the laser welding device 100 according to the first embodiment.

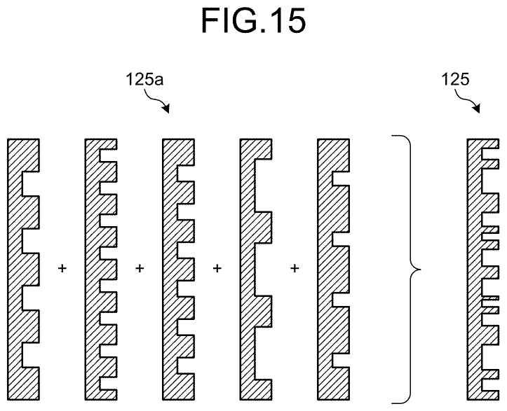

The DOE 125 forms the shape of the beam B1 of the first laser light (hereinafter, referred to as a beam shape). As conceptually exemplified in FIG. 15, for example, the DOE 125 has a configuration in which a plurality of diffraction gratings 125a with different periods are overlapped. The DOE 125 may form the beam shape by bending collimated light in a direction affected by each of the diffraction gratings 125a, or overlapping pieces of the collimated light. The DOE 125 may also be referred to as a beam shaper.

The optical head 120 may also include a beam shaper that is disposed at a latter stage of the collimating lens 121-2 and adjusts the beam shape of the second laser light, a beam shaper that is disposed at a latter stage of the filter 124 and adjusts the beam shapes of the first laser light and the second laser light, and the like. By appropriately adjusting the beam shape of the laser light L by the beam shaper, generation of welding defects may be further suppressed in welding.

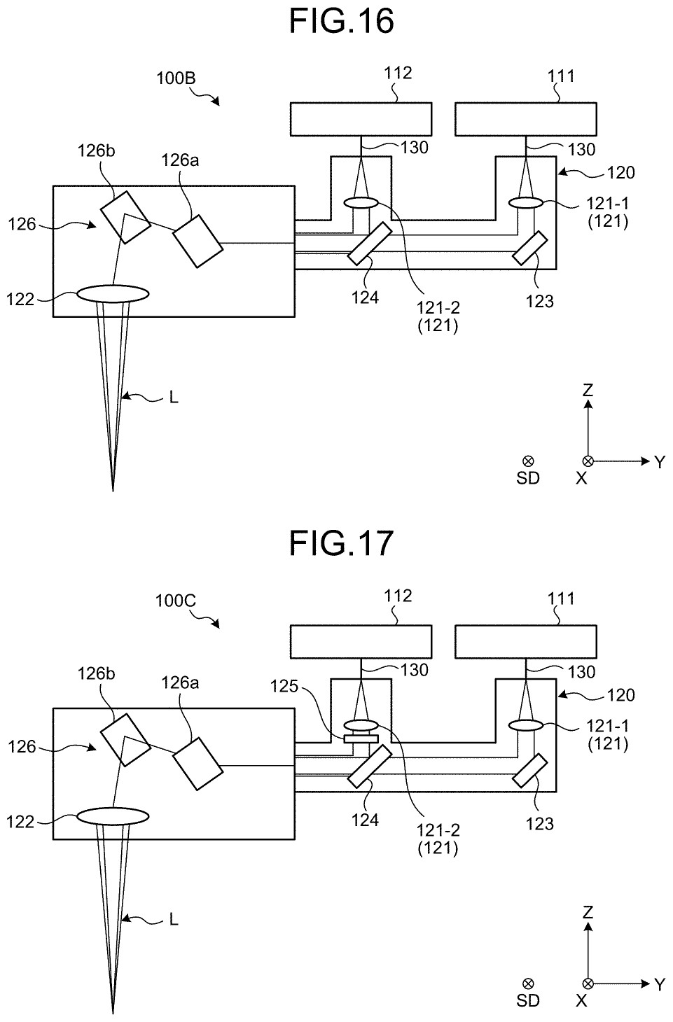

FIG. 16 is a schematic configuration diagram of a laser welding device 100B according to a third embodiment. In the present embodiment, the optical head 120 includes a galvanoscanner 126 between the filter 124 and the condensing lens 122. Except for this point, the laser welding device 100B has the same configuration as that of the laser welding device 100 according to the first embodiment.

The galvanoscanner 126 is a device that includes two mirrors 126a and 126b, and may move an irradiation position of the laser light L and sweep the laser light L without moving the optical head 120 by controlling angles of the two mirrors 126a and 126b. Each of the angles of the mirrors 126a and 126b is changed by a motor (not illustrated), for example. With this configuration, a mechanism for relatively moving the optical head 120 and the processing object W is not required, and an advantage may be obtained such that a device configuration may be downsized, for example.

FIG. 17 is a schematic configuration diagram of a laser welding device 100C according to a fourth embodiment. In the present embodiment, the optical head 120 includes the DOE 125 (beam shaper) between the collimating lens 121-2 and the filter 124. Except for this point, the laser welding device 100C has the same configuration as that of the laser welding device 100B according to the third embodiment. With this configuration, it is possible to obtain the same effect as that of the third embodiment including the galvanoscanner 126, and the same effect as that of the second embodiment including the DOE 125 (beam shaper).

Also in the present embodiment, the optical head 120 may also include a beam shaper that is disposed at a latter stage of the collimating lens 121-1 and adjusts the beam shape of the first laser light, a beam shaper that is disposed at a latter stage of the filter 124 and adjusts the beam shapes of the first laser light and the second laser light, and the like.

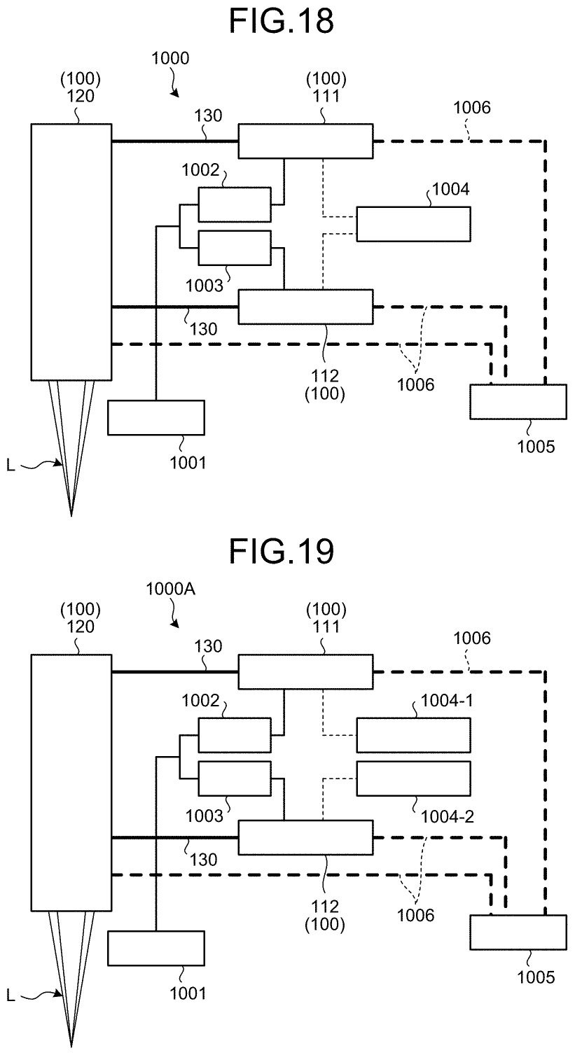

FIG. 18 is a schematic configuration diagram of a laser welding system 1000 including the laser welding device 100 according to the first embodiment. Alternatively, the laser welding system 1000 may include the laser welding devices 100A to 100C according to the other embodiments in place of the laser welding device 100.

The laser welding system 1000 includes a main power supply 1001, sub-power supplies 1002 and 1003, an integrated controller 1004, and a cooling mechanism 1005 in addition to the laser welding device 100.

The main power supply 1001 supplies electric power to the sub-power supplies 1002 and 1003. The sub-power supply 1002 supplies electric power to the laser device 111, and the sub-power supply 1003 supplies electric power to the laser device 112.

The integrated controller 1004 controls operations of both of the laser device 111 and the laser device 112. Specifically, the integrated controller 1004 may control power, an oscillation timing, and a wavelength of the laser light output from the laser devices 111 and 112, and may control an operation related to sweeping, for example, an operation of a relative movement mechanism or the galvanoscanner 126. Due to this, the laser device 111 (first laser oscillator) and the laser device 112 (second laser oscillator) may be integrally and more securely controlled. The integrated controller 1004 is an example of a controller.

The cooling mechanism 1005 includes piping 1006 through which a refrigerant such as a coolant flows, for example. Respective pieces of the piping 1006 are disposed to pass through the laser devices 111 and 112, and the optical head 120. The cooling mechanism 1005 may switch between supply and stop of the refrigerant flowing through the respective pieces of the piping 1006, change a flow rate, or adjust a temperature of the refrigerant. Due to this, the laser devices 111 and 112, and the optical head 120 may be cooled, and for example, operations of the laser devices 111 and 112 may be stabilized, or excessive temperature rise in the optical head 120 may be suppressed. The operation of the cooling mechanism 1005 may be controlled by the integrated controller 1004.

FIG. 19 is a schematic configuration diagram of a laser welding system 1000A including the laser welding device 100 according to the first embodiment. Alternatively, the laser welding system 1000A may include the laser welding devices 100A to 100C according to the other embodiments in place of the laser welding device 100. In the present embodiment, the laser welding system 1000A has the same configuration as that of the laser welding system 1000 according to the fifth embodiment except that the laser welding system 1000A includes a controller 1004-1 for the laser device 111 and a controller 1004-2 for the laser device 112 in place of the integrated controller 1004. With this configuration, the same effect as that of the laser welding system 1000 according to the fifth embodiment may be obtained. Each of the controllers 1004-1 and 1004-2 is an example of a controller.

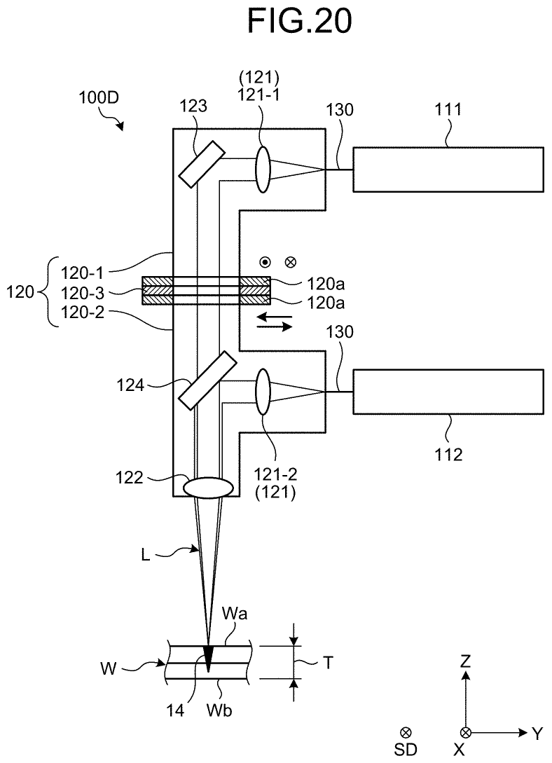

FIG. 20 is a schematic configuration diagram of a laser welding device 100D according to a seventh embodiment. The laser welding device 100D is obtained by modifying the laser welding device 100 according to the first embodiment. As illustrated in FIG. 20, in the present embodiment, the optical head 120 includes a first part 120-1, a second part 120-2, and a third part 120-3. The first part 120-1 includes the collimating lens 121-1 and the mirror 123. The second part 120-2 includes the collimating lens 121-2, the filter 124, and the condensing lens 122. The third part 120-3 is interposed between the first part 120-1 and the second part 120-2. The first laser light reflected by the mirror 123 and output from the first part 120-1 passes through an opening of the third part 120-3 to be input to the second part 120-2 and input to the filter 124. The first part 120-1, the second part 120-2, and the third part 120-3 are configured to be able to slide relatively to each other so that, while keeping a parallel state of an optical axis of the laser light output from the first part 120-1 and input to the second part 120-2, the first part 120-1, the second part 120-2, and the third part 120-3 may be shifted from each other in a direction orthogonal to the optical axis (direction orthogonal to the Z-direction). Specifically, in the example of FIG. 20, the first part 120-1 and the third part 120-3 are configured to be able to slide relatively to each other in the X-direction or a direction opposite to the X-direction in a state in which attitudes thereof with respect to the Z-direction are not changed. The second part 120-2 and the third part 120-3 are configured to be able to slide relatively to each other in the Y-direction and a direction opposite to the Y-direction in a state in which attitudes thereof with respect to the Z-direction are not changed. Specifically, flanges 120a having an annular shape and a plate shape and expanding in a direction orthogonal to the optical axis direction of the first laser light are respectively disposed at an outlet for the first laser light of the first part 120-1 and an inlet for the first laser light of the second part 120-2. These two flanges 120a hold the third part 120-3 therebetween, the third part 120-3 having an annular shape and a plate shape and expanding in the direction orthogonal to the optical axis direction of the first laser light. The two flanges 120a and the third part 120-3 may slide relatively to each other along respective abutting surfaces in a state in which attitudes thereof with respect to the Z-axis are not changed. A guiding mechanism (not illustrated) is disposed between the first part 120-1 and the third part 120-3, the guiding mechanism that guides relative sliding thereof in the X-direction and may fix them at optional relative positions in the X-direction. A guiding mechanism (not illustrated) is disposed between the second part 120-2 and the third part 120-3, the guiding mechanism that guides relative sliding thereof in the Y-direction and may fix them at optional relative positions in the Y-direction. With this configuration, by adjusting slide positions by the two guiding mechanisms, the optical axis of the first laser light input to the filter 124 and output from the filter 124 and the optical axis of the second laser light output from the filter 124 may be shifted from each other in the direction orthogonal to the optical axes. The first part 120-1 and the laser device 111, and the second part 120-2 and the laser device 112 are respectively connected to each other via the optical fibers 130 having flexibility, so that the laser devices 111 and 112 may be fixed even in a case in which the position of the first part 120-1 or the second part 120-2 is changed.

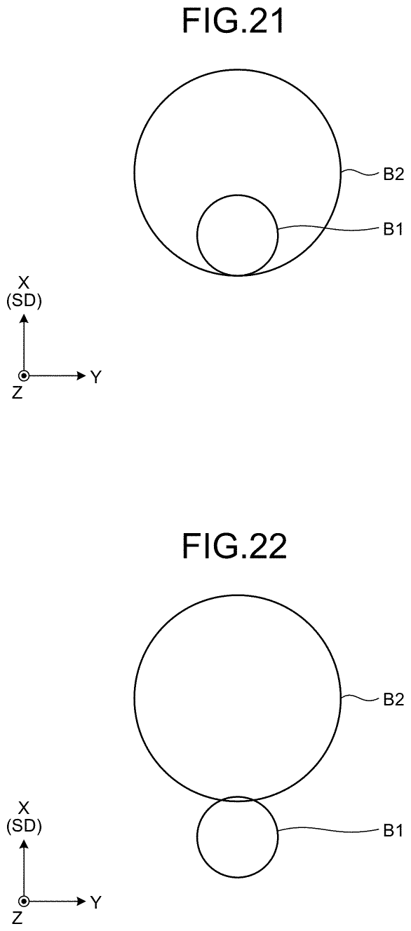

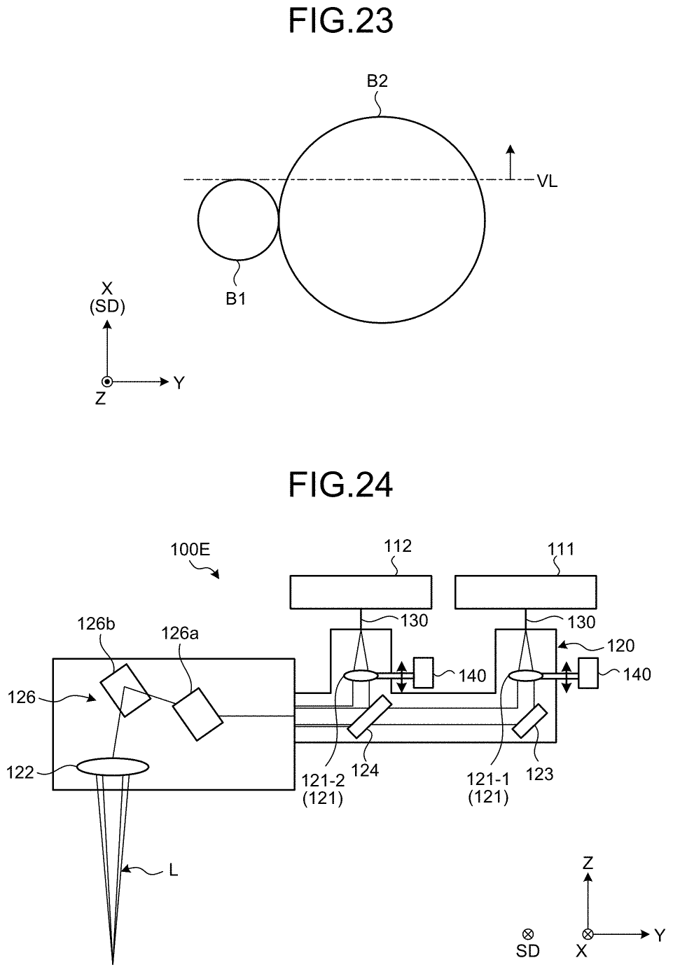

FIGS. 21 to 23 illustrate examples of the beams B1 and B2 of the laser light formed on the surface Wa of the processing object W by the laser welding device 100D. As illustrated in FIGS. 21 to 23, with the laser welding device 100D, relative positions of the beams B1 and B2 may be optionally changed. Through researches carried out by the present inventors, it has been found that the same effect as that of the first embodiment may be obtained due to the preheating effect of the beam B2 in a case in which at least part of the beam B2 (second spot) is positioned on the forward side of the sweeping direction SD as compared with the beam B1 (first spot) on the surface Wa, and a case in which the beam B1 and the beam B2 are in contact with each other or partially overlap each other as illustrated in FIGS. 21 to 23. It has been also found that, in a case in which at least part of the beam B2 is positioned on the forward side of the sweeping direction SD as compared with the beam B1, the beam B1 and the beam B2 may be separated from each other by a minute distance. FIGS. 21 to 23 are merely examples, and disposition of the beams B1 and B2 obtained by the laser welding device 100D and the sizes of the beams B1 and B2 are not limited to the examples of FIGS. 21 to 23. “The beam B2 is positioned on the forward side of the sweeping direction SD as compared with the beam B1” means that, as illustrated in FIG. 23, on the surface Wa, at least part of the beam B2 is present in a forward region in the sweeping direction SD with respect to a virtual straight line VL passing through a front end in the sweeping direction SD of the beam B1 and orthogonal to the sweeping direction SD.

FIG. 24 is a schematic configuration diagram of a laser welding device 100E according to an eighth embodiment. The laser welding device 100E is obtained by modifying the laser welding device 100B according to the third embodiment. As illustrated in FIG. 24, the laser welding device 100E includes a position adjusting mechanism 140 that variably sets the position of the collimating lens 121 in the optical axis direction. With the position adjusting mechanism 140, the sizes of the beams B1 and B2 (spot diameters D1 and D2) on the surface Wa of the processing object W may be appropriately changed. That is, the position adjusting mechanism 140 may also be referred to as a spot size variable mechanism. The same position adjusting mechanism 140 may also be applied to the condensing lens 122, may be applied to both of the collimating lens 121 and the condensing lens 122, and may be applied to the collimating lens 121 and the condensing lens 122 of each of the laser welding devices 100, 100A, 100C, 100D, and 100F according to the other embodiments.

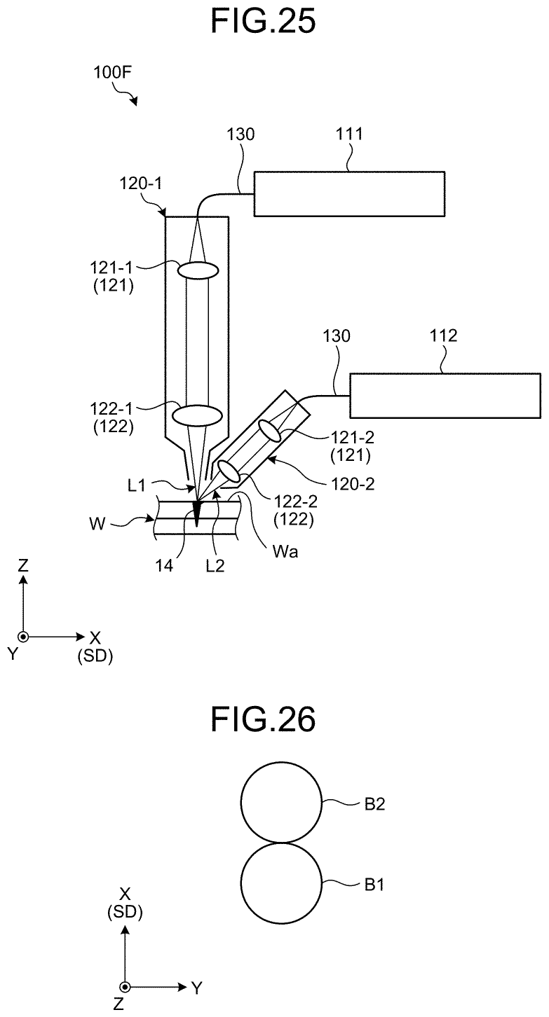

FIG. 25 is a schematic configuration diagram of a laser welding device 100F according to a ninth embodiment. In the present embodiment, the optical head 120 includes the first part 120-1 for emitting the first laser light L1 and the second part 120-2 for emitting the second laser light L2 that are respectively constituted of different bodies (housings). With this configuration, it is possible to obtain the same operation and effect as those of the embodiments described above.

FIG. 26 illustrates an example of spots of the beams B1 and B2 formed on the surface Wa of the processing object W by the laser welding devices 100 and 100A to 100F according to any of the embodiments described above. As illustrated in FIG. 26, the spot diameter of the beam B2 may be substantially equivalent to the spot diameter of the beam B1. Although not illustrated, the spot diameter of the beam B2 may be smaller than the spot diameter of the beam B1.

The embodiments have been exemplified above, but the embodiments are merely examples, and do not intend to limit the scope of the disclosure. The embodiments described above may be implemented in various other forms, and may be variously omitted, replaced, combined, or modified without departing from the gist of the disclosure. Specs such as each configuration or shape (a structure, a type, a direction, a model, a size, a length, a width, a thickness, a height, the number, disposition, a position, a material, and the like) may be appropriately modified to be implemented.

For example, at the time of sweeping the laser light for the processing object, sweeping may be performed by known wobbling, weaving, output modulation, and the like to adjust a surface area of the molten pool.

The processing object may be a metal surface on which another thin metal layer is present such as a plated metal plate.

A center of the beam of the first laser light and a center of the beam of the second laser light do not necessarily agree with each other, but may be shifted from each other.

The beam of the first laser light may be partially positioned on the outside of the beam of the second laser light.

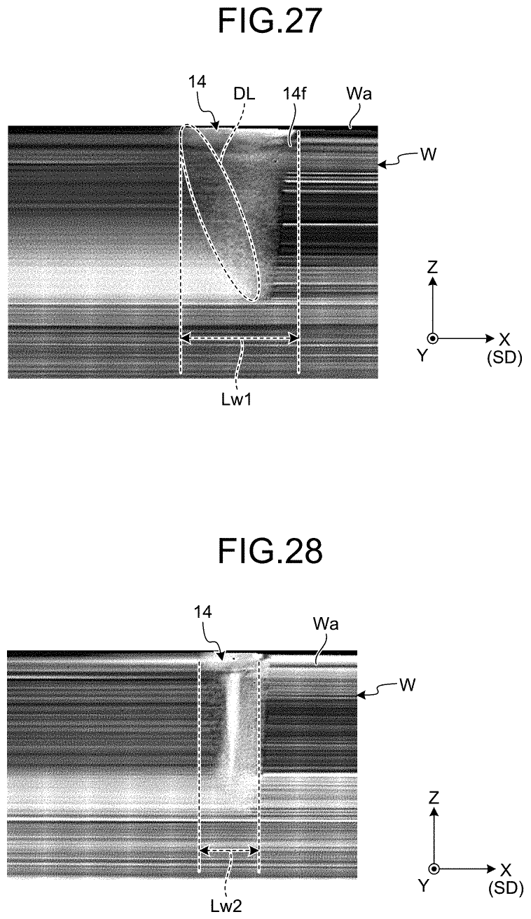

FIG. 27 is a cross-sectional view at the cross section that is along the sweeping direction SD and orthogonal to the surface Wa of the weld part 14 according to the embodiment, and is a cross-sectional view of a front end portion in the sweeping direction SD of the weld part 14. FIG. 28 is a cross-sectional view at the cross section that is along the sweeping direction SD and orthogonal to the surface Wa of the weld part 14 that is formed by singly emitting the first laser light with the same power as that in the case of FIG. 27 as a reference example, and is a cross-sectional view of a front end portion in the sweeping direction SD of the weld part 14.

In the cross-sectional views illustrated in FIGS. 27 and 28, an outline of the molten pool (weld part 14) is visualized by image processing. The molten pool formed by processing with a hybrid laser that emits the first laser light and the second laser light according to the present embodiment as illustrated in FIG. 27 leaves a long tail rearward in the sweeping direction SD as represented by a dashed line frame DL in FIG. 27 as compared with a molten pool formed by processing with a fiber laser that emits only the first laser light as illustrated in FIG. 28. As illustrated in FIG. 27, a front part 14f of the molten pool (weld part 14) according to the present embodiment projects forward in the sweeping direction SD. Accordingly, a length Lw1 (refer to FIG. 27) in the sweeping direction SD of the molten pool formed by processing with the hybrid laser is longer than a length Lw2 (refer to FIG. 28) in the sweeping direction SD of the molten pool formed by processing with the fiber laser. That is, the molten pool is enlarged by processing with the hybrid laser as compared with processing with the fiber laser. With hybrid laser processing according to the present embodiment, which emits the first laser light and the second laser light, emission of the second laser light (blue laser light) enlarges the molten pool, further stabilizes heat convection inside, and enlarges a keyhole opening, allowing steam pressure at the time of evaporation to easily escape to the outside, so that it may be estimated that generation of spatters may be suppressed and a stabilized molten pool may be obtained as compared with single emission of the first laser light.

According to the present disclosure, for example, it is possible to obtain a welding method, a laser welding system, a metallic member, an electric component, and an electronic appliance that may further suppress a welding defect.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A welding method comprising
performing welding by emitting laser light moving in a sweeping direction relatively to a processing object onto a surface of the processing object to melt a portion of the processing object onto which the laser light is emitted, wherein
the laser light includes: first laser light having a wavelength equal to or larger than 800 nm and equal to or smaller than 1200 nm; and second laser light having a wavelength equal to or smaller than 550 nm.

2. The welding method according to claim 1, wherein the wavelength of the second laser light is equal to or larger than 400 nm and equal to or smaller than 500 nm.

3. The welding method according to claim 1, wherein the processing object is any one of a copper-based metallic material, an aluminum-based metallic material, a nickel-based metallic material, an iron-based metallic material, and a titanium-based metallic material.

4. The welding method according to claim 1, wherein, on the surface, at least part of a second spot formed on the surface by the second laser light is positioned on a forward side of the sweeping direction as compared with a first spot formed on the surface by the first laser light.

5. The welding method according to claim 4, wherein the first spot and the second spot at least partially overlap each other on the surface.

6. The welding method according to claim 4, wherein a second outer edge of the second spot surrounds a first outer edge of the first spot on the surface.

7. The welding method according to claim 4, wherein the outer diameter of the second spot is set to satisfy the following expression (1):
wb−400<D2<wb+400 (1),
where a width of a weld part formed on the surface in a case of emitting only the first laser light without emitting the second laser light is wb, and an outer diameter of the second spot in a case of emitting the first laser light and the second laser light is D2.

8. The welding method according to claim 1, wherein an output ratio of power of the second laser light to power of the first laser light is equal to or larger than 0.1 and equal to or smaller than 2 on the surface.

9. The welding method according to claim 1, wherein the laser light includes a plurality of beams.

10. The welding method according to claim 9, wherein the beams are formed by a beam shaper.

11. The welding method according to claim 1, wherein arithmetic average roughness of the surface is equal to or smaller than 21 μm.

12. The welding method according to claim 1, wherein a sweeping speed of the laser light on the surface is equal to or higher than 50 mm/s.

13. A laser welding system comprising:
a first laser oscillator configured to oscillate first laser light having a wavelength equal to or larger than 800 nm and equal to or smaller than 1200 nm;
a second laser oscillator configured to oscillate second laser light having a wavelength equal to or smaller than 500 nm;
an optical head configured to emit laser light including the first laser light and the second laser light onto a surface of a processing object to melt a portion of the processing object onto which the laser light is emitted and perform welding;
a controller configured to control a laser oscillation timing and power of the first laser light and the second laser light; and
a cooler configured to cool the first laser oscillator, the second laser oscillator, and the optical head, wherein
the laser welding system is configured such that the processing object and the laser light are able to be moved relatively to each other so as to move the laser light in a sweeping direction relatively to the processing object.

14. The laser welding system according to claim 13, comprising a galvanoscanner configured to change an emitting direction of the laser light such that the laser light moves in the sweeping direction on the surface.

15. The laser welding system according to claim 14, comprising a beam shaper configured to divide the laser light into a plurality of beams.

16. A metallic member comprising:
a first surface;
a second surface on a back side of the first surface; and
a weld part extending along the first surface, wherein
the weld part includes:
a weld metal extending from the first surface toward the second surface; and
a heat affected part positioned around the weld metal, and
the weld metal includes:
a first part positioned to be separated from the first surface in a thickness direction from the first surface toward the second surface; and
a second part positioned between the first part and the first surface, wherein an average value of cross-sectional areas of crystal grains at a cross section orthogonal to an extending direction of the weld part of the second part is larger than the first part.

17. The metallic member according to claim 16, wherein the average value of the cross-sectional areas of the crystal grains included in the second part is 1.8 times or more the average value of the cross-sectional areas of the crystal grains included in the first part.

18. A metallic member comprising:
a first surface; a second surface on a back side of the first surface; and
a weld part extending along the first surface, wherein
the weld part includes:
a weld metal extending from the first surface toward the second surface; and
a heat affected part positioned around the weld metal, and
wherein a first ratio of number of grain boundaries is represented by the following expression (3-1):
Rb1=N12/N11 (3-1)
where Rb1 is the first ratio of the number of grain boundaries, N11 is the number of grain boundaries intersecting with a straight test line having a predetermined length along the first surface at a test cross section that is orthogonal to the first surface and along an extending direction of the weld part, and N12 is the number of grain boundaries intersecting with the straight test line having the predetermined length extending in a direction orthogonal to the first surface at the test cross section, and
the weld metal includes:
a third part positioned to be separated from the first surface in a thickness direction from the first surface toward the second surface; and
a fourth part positioned between the third part and the first surface, wherein the first ratio of the number of grain boundaries of the fourth part is lower than the first ratio of the number of grain boundaries of the third part.

19. A metallic member comprising:
a first surface;
a second surface on a back side of the first surface; and
a weld part extending along the first surface, wherein the weld part includes:
a weld metal extending from the first surface toward the second surface; and
a heat affected part positioned around the weld metal,
a second ratio of the number of grain boundaries is represented by the following expression (3-2):
Rb2=max(N22/N21,N21/N22) (3-2)
where Rb2 is the second ratio of the number of grain boundaries, N21 is the number of grain boundaries intersecting with a straight test line having a predetermined length extending in a first direction between a direction along the first surface and a direction orthogonal to the first surface at a test cross section that is orthogonal to the first surface and along an extending direction of the weld part, N22 is the number of grain boundaries intersecting with the straight test line having the predetermined length extending in a second direction orthogonal to the first direction at the test cross section, and max(N22/N21, N21/N22) is (N22/N21) in a case in which (N22/N21) is equal to or larger than (N21/N22), and (N21/N22) in a case in which (N22/N21) is smaller than (N21/N22), and
the weld metal includes:
a third part positioned to be separated from the first surface in a thickness direction from the first surface toward the second surface; and
a fourth part positioned between the third part and the first surface, wherein the second ratio of the number of grain boundaries of the fourth part is higher than the second ratio of the number of grain boundaries of the third part.

20. A metallic member comprising:
a first surface;
a second surface on a back side of the first surface; and
a weld part extending along the first surface, wherein
the weld part includes:
a weld metal extending from the first surface toward the second surface; and
a heat affected part positioned around the weld metal,
a first ratio of the number of grain boundaries is represented by the following expression (3-1):
Rb1=N12/N11 (3-1)
where Rb1 is the first ratio of the number of grain boundaries, N11 is the number of grain boundaries intersecting with a straight test line having a predetermined length along the first surface at a test cross section that is orthogonal to the first surface and along an extending direction of the weld part, and N12 is the number of grain boundaries intersecting with the straight test line having the predetermined length extending in a direction orthogonal to the first surface at the test cross section, and
a second ratio Rb2 of the number of grain boundaries is represented by the following expression (3-2):
Rb2=max(N22/N21,N21/N22) (3-2)
where Rb2 is the second ratio of the number of grain boundaries, N21 is the number of grain boundaries intersecting with a straight test line having a predetermined length extending in a first direction between a direction along the first surface and a direction orthogonal to the first surface at a test cross section that is orthogonal to the first surface and along the extending direction of the weld part, N22 is the number of grain boundaries intersecting with the straight test line having the predetermined length extending in a second direction orthogonal to the first direction at the test cross section, and max(N22/N21, N21/N22) is (N22/N21) in a case in which (N22/N21) is equal to or larger than (N21/N22), and (N21/N22) in a case in which (N22/N21) is smaller than (N21/N22), and
the weld metal includes:
a third part positioned to be separated from the first surface in a thickness direction from the first surface toward the second surface; and
a fourth part positioned between the third part and the first surface, the first ratio of the number of grain boundaries of the fourth part is lower than the first ratio of the number of grain boundaries of the third part, and the second ratio of the number of grain boundaries is higher than the second ratio of the number of grain boundaries of the third part.

21. An electric component comprising a conductor formed of the metallic member according to claim 16.

22. An electronic appliance comprising a conductor formed of the metallic member according to claim 16.
